(19) United States
(12) Patent Application Publication
(10) Pub. No.: US 2004/0109201 A1
(43) Pub. Date: Jun. 10, 2004

(54) Image arrangement method, image arrangement device, and image arrangement program storage medium

(75) Inventor: Eiji Teraue, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/713,257

(22) Filed: Nov. 17, 2003

(30) Foreign Application Priority Data
Nov. 22, 2002 (JP) 2002-339015
Aug. 1, 2003 (JP) 2003-285208

(51) Int. Cl. H04N 1/40; H04N 1/387; G06K 15/02

(52) U.S. Cl. 358/1.18; 358/450

(57) ABSTRACT

A method and device is provided for arranging a large number of images in a sheet of paper, thereby using the sheet of paper efficiently. When arrangement a plurality of images in a sheet of paper, a total sum of the areas of images contained in the sheet in a first arrangement and a total sum of the areas of images contained in the sheet in a second arrangement are calculated, and the images are arranged in a sheet of paper in one of the arrangements that is adopted when the larger total sum is calculated. By arranging the images in this way, the remaining blank area of the sheet can be reduced, and the sheet of paper can be used efficiently.

### BACKGROUND OF THE INVENTION

1. Field of the Invention

The present invention relates to an image arrangement method and an image arrangement device that arrange a plurality of images on a sheet of paper, and to an image arrangement program storage medium that stores an image arrangement program that is executed by a computer and makes the computer function as the image arrangement device.

2. Description of the Related Art

In the field of printing, desktop publishing (DTP), which uses a computer to perform an editing work, has been conventionally used widely. The DTP, which embodies the idea that what you see is what you get (WYSIWYG), allows the operator to edit characters or images while viewing them on the display screen, so that, before printing an image or the like or making a proof thereof, the operator can have an image of what the printed image or the like looks like.

In a conventional manner, when arranging and printing a plurality of images on a sheet of paper, the operator operates a computer to manually arrange the images in a frame which is assumed to have the same size as the sheet of paper. In recent years, an image arrangement application has been used which automatically and sequentially arranges a plurality of input images in a frame. In the automatic image arrangement using the image arrangement application, the plurality of images are sequentially arranged in a frame in the order of input while avoiding overlaps. Then, when an image extends off the frame, the images having been arranged in the frame before that image are printed on a sheet of paper as one image.

However, according to the method described above, depending on the sizes of images arranged in a frame and the order of input thereof, there is a possibility that a desired number of images cannot be contained in the frame, or that, when a frame image is printed on a sheet of paper, a substantial area of the sheet remains blank, resulting in an reduced efficiency of sheet utilization. In order to solve the problem, in a patent reference (Japanese Patent Laid-Open No. 2002-232683), there is described a method of previously dividing a frame into a specified number of regions and arranging images within the respective divisional regions. According to this method, the number of images arranged on a sheet of paper can be previously specified, and the images can be arranged equally on the sheet.

### SUMMARY OF THE INVENTION

However, the method described in the patent reference has problems that: if an image larger than a divisional region is to be placed in the region, the image is trimmed to a size suitable for the region; and if an image smaller than a divisional region is placed in the region, a significant blank area remains on the sheet.

In view of the circumstances described above, an object of the present invention is to provide an image arrangement method and an image arrangement device that efficiently arrange many images on a sheet of paper, and an image arrangement program storage medium that stores an image arrangement program that is executed by a computer and makes the computer function as the image arrangement device.

An image arrangement method according to the present invention that attains the object described above comprises:

a first area calculation step of calculating a total sum of the areas of images, of a plurality of images, that are contained in a sheet of paper in a first arrangement;

a second area calculation step of calculating a total sum of the areas of images, of a plurality images, that are contained in the sheet of paper in a second arrangement different from the first arrangement; and

an image arrangement step of arranging images in the sheet of paper in an arrangement that is adopted when the larger one of the total sums calculated in the first and second area calculation steps is calculated.

When a plurality of images varying in size or shape are arranged in a sheet of paper, the remaining blank area of the sheet varies depending on the arrangement thereof, and thus, the number of images arranged in the sheet varies.

According to the image arrangement method of the present invention, the plurality of images are arranged in the sheet of paper in one of the first and second arrangements which provides the larger total sum of the areas of images contained in the sheet. Since the arrangement that provides the larger total sum of the areas of images in the sheet of paper is adopted, an increased number of images can be arranged in one sheet of paper, and one sheet of paper can be efficiently used.

Preferably, in the image arrangement method according to the present invention, the first area calculation step is to calculate a total sum of the areas of images, of the plurality of images, that are contained in the sheet of paper in the first arrangement, the first arrangement resulting from arranging the plurality of images in the sheet of paper sequentially in a first order according to a predetermined algorithm, and

the second area calculation step is to calculate a total sum of the areas of images, of the plurality of images, that are contained in the sheet of paper in the second arrangement, the second arrangement resulting from arranging the plurality of images in the sheet of paper sequentially in a second order different from the first order according to the predetermined algorithm.

If a plurality of images are arranged in a sheet of paper in a plurality of arrangement orders according to a predetermined algorithm, a plurality of image arrangements can be provided. Since the total sums of the areas of images contained in the sheet of paper in the first and second arrangement orders according to the predetermined algorithm are calculated, and the plurality of images are arranged adopting one of the arrangement orders that provides the larger total sum, the sheet of paper can be efficiently used.

In addition, preferably, in the image arrangement method according to the present invention, if an image extends off the sheet of paper when the plurality of images are arranged in the sheet of paper in the first order, the second order adopted in the second area calculation step to calculate the total sum is that the extending-off image is placed first in the sheet.

When a plurality of images are sequentially arranged in a sheet of paper, an image extending off the sheet is often a large one. Since the large image is placed first, and then, the remaining smaller ones are placed in the remaining regions, an arrangement that provides a high utilization of the sheet of paper can be readily achieved.

In addition, preferably, in the image arrangement method according to the present invention, the algorithm is that each of the plurality of images is sequentially arranged in the sheet of paper so that the remaining blank area can accommodate a possible largest rectangle.

The preferable image arrangement method described above allows a plurality of images varying in shape or size to be arranged in a sheet of paper with a high occupancy.

In addition, preferably, in the image arrangement method according to the present invention, the first area calculation step is to calculate a total sum of the areas of images, of the plurality of images, that are contained in the sheet of paper in the first arrangement, the first arrangement resulting from arranging the plurality of images in the sheet of paper sequentially in a predetermined order according to a first algorithm, and

the second area calculation step is to calculate a total sum of the areas of images, of the plurality of images, that are contained in the sheet of paper in the second arrangement, the second arrangement resulting from arranging the plurality of images sequentially in the sheet of paper in the predetermined order according to a second algorithm different from the first algorithm.

A plurality of image arrangements can be provided by arranging a plurality of images in a predetermined arrangement order according to a plurality of algorithms, rather than by arranging a plurality of images in a plurality of arrangement order according to a predetermined algorithm as described above. Therefore, the sheet utilization can be improved by calculating the total sums of the areas of images that are contained in a sheet of paper when a plurality of images are arranged in the sheet of paper in a predetermined order according to the first and second algorithms, and adopting one of the algorithms which provides the larger total sum to arrange the images.

In addition, preferably, in the image arrangement method according to the present invention, the first area calculation step is to calculate a total sum of the areas of images, of the plurality of images, that are contained in the sheet of paper in the first arrangement, the first arrangement resulting from arranging the plurality of images in the sheet of paper sequentially in a first order according to a first algorithm,

the second area calculation step is to calculate a total sum of the areas of images, of the plurality of images, that are contained in the sheet of paper in the second arrangement, the second arrangement resulting from arranging the plurality of images in the sheet of paper sequentially in a second order different from the first order according to the first algorithm,

the image arrangement method further comprises:

a third area calculation step of calculating a total sum of the areas of images, of the plurality of images, that are contained in the sheet of paper in a third arrangement, the third arrangement resulting from arranging the plurality of images in the sheet of paper sequentially in the first order according to a second algorithm different from the first algorithm; and

a fourth area calculation step of calculating a total sum of the areas of images, of the plurality of images, that are contained in the sheet of paper in a fourth arrangement, the fourth arrangement resulting from arranging the plurality of images in the sheet of paper sequentially in the second order according to the second algorithm, and

the area arrangement step is to arrange the images in the sheet of paper in an arrangement that is adopted when the largest one of the total sums calculated in the first, second, third and fourth area calculation steps is calculated.

Since the plurality of image arrangement algorithms and the plurality of arrangement orders are combined in various ways to arrange a plurality of images in a sheet of paper, various image arrangements are provided. By adopting one of these image arrangements which provides the largest total sum of the areas of images contained in the sheet of paper, the sheet of paper can be further efficiently used.

An image arrangement device according to the present invention comprises:

a first area calculation section that calculates a total sum of the areas of images, of a plurality of images, that are contained in a sheet of paper in a first arrangement;

a second area calculation section that calculates a total sum of the areas of images, of a plurality of image, that are contained in the sheet of paper in a second arrangement different from the first arrangement; and

an image arrangement section that arranges images in the sheet of paper in an arrangement that is adopted when the larger one of the total sums calculated by the first and second area calculation sections is calculated.

With the image arrangement device according to the present invention, an increased number of images can be arranged in a sheet of paper, and the sheet of paper can be efficiently used.

The image arrangement device according to the present invention is described herein only with reference to a basic configuration thereof. However, this is simply intended to avoid overlaps, and the present invention includes various other configurations of the image arrangement device adapted for the various implementations of the image arrangement method described above.

An image arrangement program storage medium according to the present invention stores an image arrangement program, and the image arrangement program comprises:

a first area calculation section that calculates a total sum of the areas of images, of a plurality of images, that are contained in a sheet of paper in a first arrangement;

a second area calculation section that calculates a total sum of the areas of images, of a plurality of images, that are contained in the sheet of paper in a second arrangement different from the first arrangement; and

an image arrangement section that arranges images in the sheet of paper in an arrangement that is adopted when the larger one of the total sums calculated by the first and second area calculation sections is calculated.

By executing the image arrangement program according to the present invention in a computer, the computer can be made to function as the image arrangement device described above.

The image arrangement device described above and the image arrangement program described above share the same component names, such as the first area calculation section and the second area calculation section. As for the image arrangement program, these names refer to software having the respective functions, and as for the image arrangement device, these names refer to software and hardware having the respective functions.

Furthermore, as for the components, such as the first area calculation section, of the image arrangement program according to the present invention, the function of one component may be provided by one program product or a plurality of program products, or the functions of a plurality of components may be provided by one program product. Furthermore, the components may perform the respective functions by themselves, or may instruct another program or program component incorporated in the computer to perform the functions.

According to the present invention, an increased number of images can be arranged in a sheet of paper, and the sheet of paper can be efficiently used.

### BRIEF DESCRIPTION OF THE DRAWINGS

FIG. 1 is a diagram showing the whole of an image processing system to which an embodiment of the present invention is applied;

FIG. 2 is a perspective view of a personal computer;

FIG. 3 shows a hardware configuration of the personal computer;

FIG. 4 is a conceptual diagram showing a CD-ROM, which is an embodiment of an image arrangement program storage medium according to the present invention;

FIG. 5 is a functional block diagram of an image arrangement device, which is the personal computer that is made to function as one embodiment of an image arrangement device according to the present invention;

FIG. 6 shows images transmitted to a first area calculation section;

FIG. 7 shows a conceptual image of a sheet of paper in which a first image is placed according to a predetermined algorithm;

FIGS. 8(A) and 8(B) show conceptual images of the sheet in which a second image is further placed in the state shown in FIG. 7 according to the predetermined algorithm;

FIG. 9 shows a conceptual image of the sheet in which a third image is further placed in the state shown in FIG. 8 (A) according to the predetermined algorithm;

FIG. 10 shows a conceptual image of the sheet in which images are placed in a second order according to the predetermined algorithm;

FIG. 11 shows a conceptual image of the sheet in which images are placed in a predetermined order according to a second algorithm;

FIG. 12 is a conceptual diagram showing a CD-ROM, which is a second embodiment of the image arrangement program storage medium according to the present invention;

FIG. 13 is a functional block diagram of an image arrangement device according to a third embodiment of the present invention; and

FIG. 14 shows a conceptual image of the sheet in which images are placed in the second order according to the second algorithm.

### DETAILED DESCRIPTION OF THE PREFERRED EMBODIMENTS

Now, embodiments of the present invention will be described.

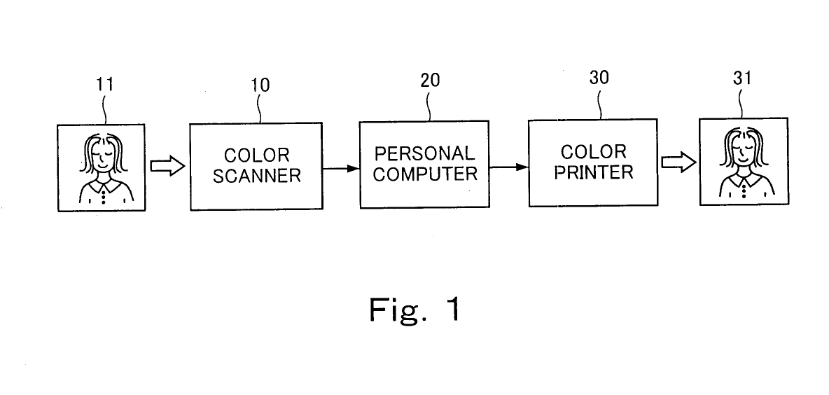

FIG. 1 is a diagram showing the whole of an image processing system to which an embodiment of the present invention is applied.

In this drawing, a color scanner 10 is shown. The color scanner 10 reads an original image 11 in and produces a three-color image data of cyan (C), magenta (M) and yellow (Y). The three-color image data is input to a personal computer 20. The personal computer 20 converts the image data scanned in by the color scanner 10 into image data to be output which is suitable for a color printer 30 described later. The image data to be output is input to the color printer 30, and the color printer 30 outputs the input image data by printing. Thus, a print image 31 is formed.

A characteristic of the embodiment of the present invention applied to the image processing system shown in FIG. 1 lies in the processing performed in the personal computer 20. In the following, the personal computer 20 will be described.

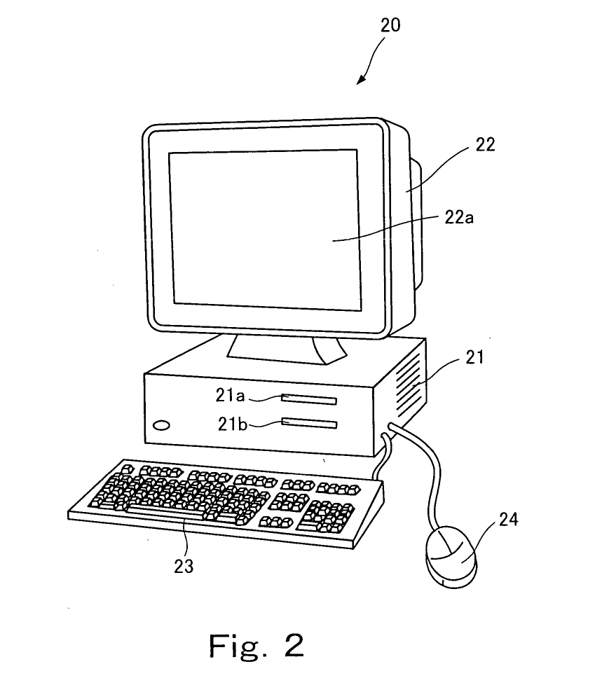

FIG. 2 is a perspective view of the personal computer 20.

Viewed from the outside, the personal computer 20 comprises a main system 21, an image display unit 22 that displays an image on a display screen 22a in response to an instruction from the main system 21, a keyboard 23 that inputs various types of information associated with key manipulations to the main system 21, and a mouse 24 that points at an icon or the like displayed at any position in the display screen 22a for selecting the instruction corresponding to the icon or the like. Viewed from the outside, the main system 21 has an FD loading opening 21a for loading of a flexible disc (abbreviated as FD, hereinafter) and a CD-ROM loading opening 21b for loading of a CD-ROM.

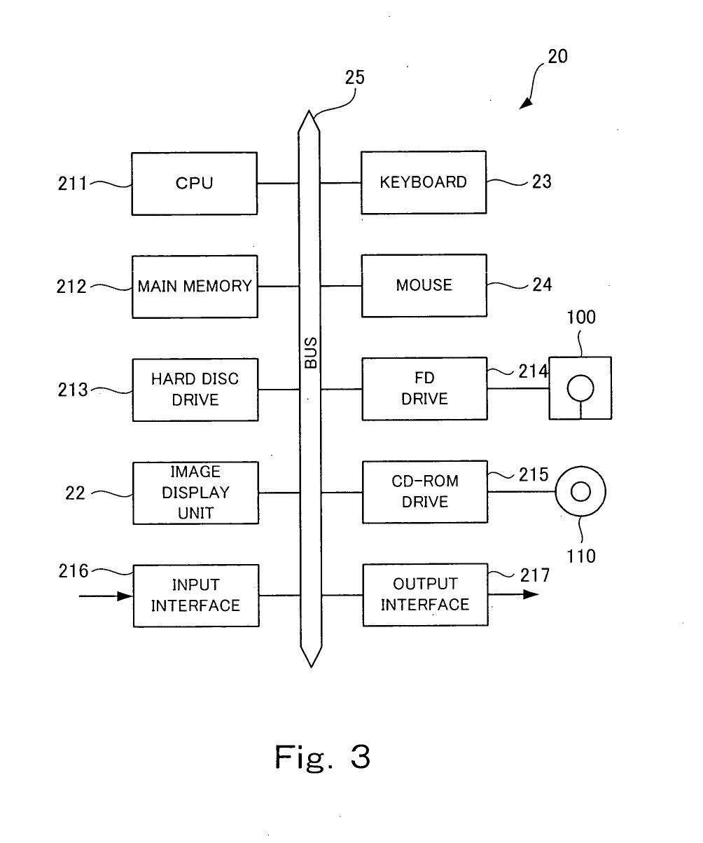

FIG. 3 shows a hardware configuration of the personal computer 20.

As shown in FIG. 3, the main system 21 shown in FIG. 2 incorporates therein a CPU 211 that executes various programs, a hard disc drive 213 that stores various programs, data or the like, a main memory 212 in which a program stored in the hard disc drive 213 is read and developed for execution by the CPU 211, an FD drive 214 that receives an FD 100 and accesses the FD 100, a CD-ROM drive 215 that accesses a CD-ROM 110, an input interface 216 that receives image data from the color scanner 10 shown in FIG. 1, and an output interface 217 that sends the image data to an external device, such as the color printer 30 shown in FIG. 1. These components and the image display unit 22, the keyboard 22 and the mouse 24 shown in FIG. 1 are connected to each other via a bus 25.

In the CD-ROM 110, there is stored an image arrangement program that makes the personal computer 20 function as an embodiment of an image arrangement device according to the present invention. The CD-ROM 110 is loaded into the CD-ROM drive 215, and the image arrangement program stored in the CD-ROM 110 is uploaded to the personal computer 20 and stored in the hard disc drive 213. In this way, the personal computer 20 can function as the image arrangement device according to one embodiment of the present invention.

Now, the image arrangement program executed in the personal computer 20 will be described.

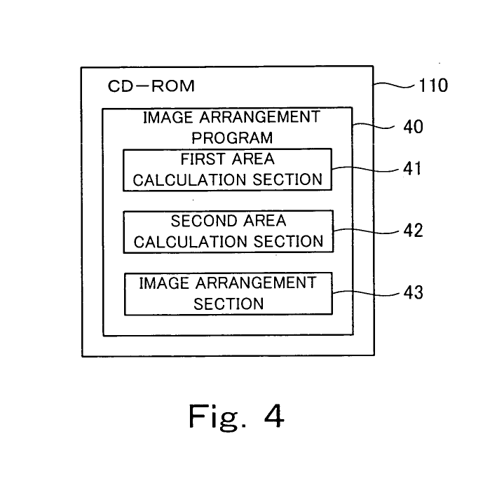

FIG. 4 is a conceptual diagram showing the CD-ROM 110, which is an embodiment of an image arrangement program storage medium according to the present invention.

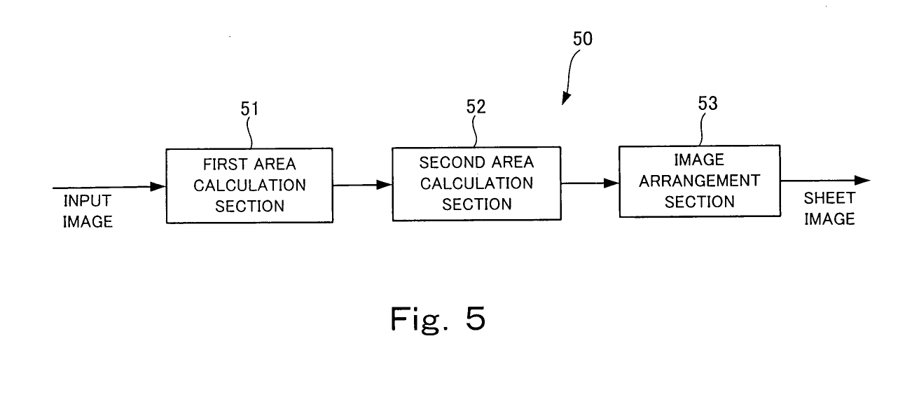

An image arrangement program 40 comprises a first area calculation section 41, a second area calculation section 42 and an image arrangement section 43. The first area calculation section 41 is an example of a first area calculation section in the image arrangement program according to the present invention. Similarly, the second area calculation section 42 is an example of a second area calculation section in the image arrangement program according to the present invention, and the image arrangement section 43 is an example of an image arrangement section in the image arrangement program according to the present invention. Details of the sections in the image arrangement program 40 will be described along with operations of various sections in an image arrangement device 50, which is an embodiment of the image arrangement device according to the present invention shown in FIG. 5.

FIG. 5 is a functional block diagram of the image arrangement device 50, which is the personal computer 20 shown in FIG. 1 having the image arrangement program 40 installed therein and functioning as one embodiment of the image arrangement device according to the present invention.

The image arrangement device 50 shown in FIG. 5 comprises a first area calculation section 51, a second area calculation section 52 and an image arrangement section 53. Once the image arrangement program 40 is installed in the personal computer 20, the first area calculation section 41 of the image arrangement program 40 constitutes the first area calculation section 51 in FIG. 5. Similarly, the second area calculation section 42 constitutes the second area calculation section 52, and the image arrangement section 43 constitutes the image arrangement section 53.

A plurality of images having different sizes or shapes read by the color scanner 10 in FIG. 1 are transmitted to the image arrangement device 50 shown in FIG. 5 through the input interface 216 shown in FIG. 3.

Once receiving the plurality of images, the first area calculation section 51 calculates a total sum of the areas of images that can be contained in a sheet of paper when the plurality of images are arranged in the sheet in a first order (described later) according to a predetermined algorithm (the total sum calculated in the first area calculation section will be referred to as a first total sum, hereinafter). In this embodiment, the predetermined algorithm adopted is that a high priority is given to the upper left of the sheet, and each image is placed so that the remaining blank area of the sheet can accommodate a possible largest rectangle. The first order is “the order of transmission of the images to the image arrangement device 50”. The first order adopted is an example of a first order according to the present invention, and the algorithm adopted by the first area calculation section 51 is an example of a predetermined algorithm according to the present invention. When the images are sequentially placed on the sheet, if there is an image extending off the sheet (referred to as an extending-off image hereinafter), the first area calculation section 51 informs the second area calculation section 52 of the extending-off image. The first area calculation section 51 is an example of a first area calculation section in the image arrangement device according to the present invention.

The second area calculation section 52 calculates a total sum of the areas of images that can be contained in a sheet of paper when the plurality of images are arranged in the sheet in a second order (described later) according to the predetermined algorithm (the total sum calculated in the second area calculation section will be referred to as a second total sum, hereinafter) In this embodiment, the second order adopted is such an order that “the extending-off image or another image which is the last to be placed by the first area calculation section 51 is first placed, and thereafter, the remaining images are placed in the order of transmission thereof to the image arrangement device 50”. The second order is an example of a second order according to the present invention, and the second area calculation section 52 is an example of a second area calculation section in the image arrangement device according to the present invention.

The image arrangement section 53 compares the first total sum calculated by the first area calculation section 51 with the second total sum calculated by the second area calculation section 52 and places the images in an arrangement for which the larger total sum results. In addition, the image arrangement section 53 transmits the sheet image representing the whole sheet having plural images arranged therein to the color printer 30 in FIG. 1 via the output interface 217 in FIG. 3. The image arrangement section 53 is an example of an image arrangement section in the image arrangement device according to the present invention.

The image arrangement section 50 is essentially configured as described above. Now, description will be made of a sequence of processings of arranging a plurality of images read by the color scanner 10 in FIG. 1 in a sheet of paper using the image arrangement device 50 and outputting the sheet image by the color printer 30.

First, the plurality of images read by the color scanner 10 in FIG. 1 are transmitted to the image arrangement device 50 in FIG. 5 via the input interface 216 in FIG. 3.

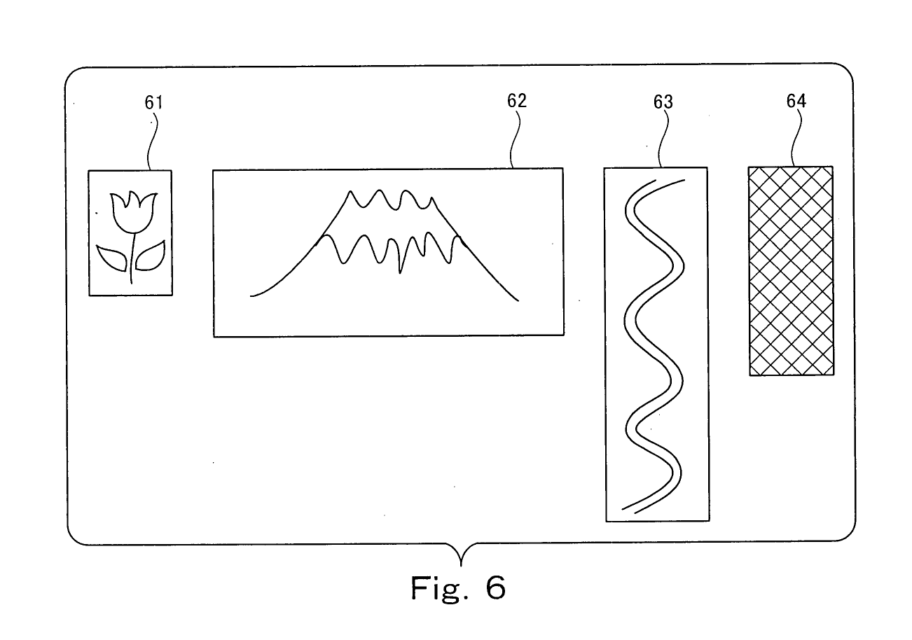

FIG. 6 shows images transmitted to the image arrangement device 50. The image arrangement device 50 sequentially receives four images 61, 62, 63 and 64 varying in size or shape. The first area calculation section 51 calculates a total sum of the areas of images that can be contained in the sheet of paper when the images are arranged in the sheet in the first order (order of transmission of the images) according to the predetermined algorithm (a high priority is given to the upper left of the sheet, and each image is placed so that the remaining blank area of the sheet can accommodate a possible largest rectangle).

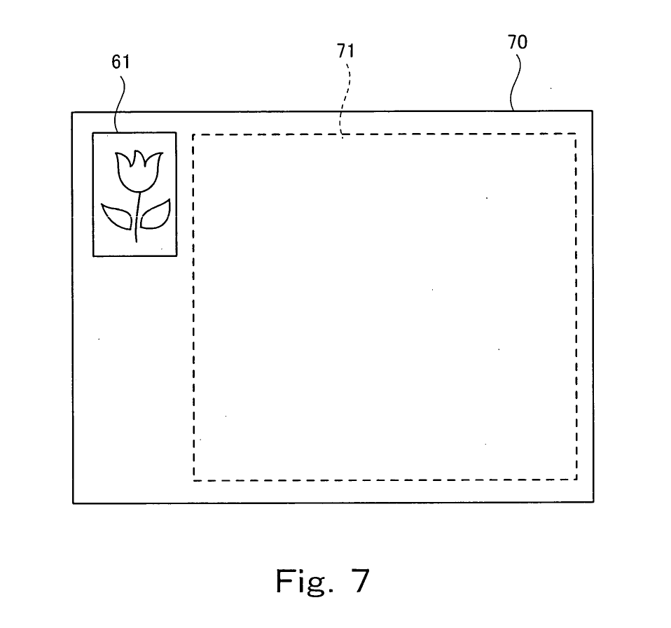

FIG. 7 shows a conceptual image of a sheet of paper in which a first image is placed according to the algorithm. As shown in FIG. 7, the image 61, which is transmitted first, is placed at the upper left of a sheet of paper 70. Here, a rectangle 71 is the largest of the rectangles that can be accommodated by the remaining area of the sheet 70 (referred to as a largest rectangle, hereinafter).

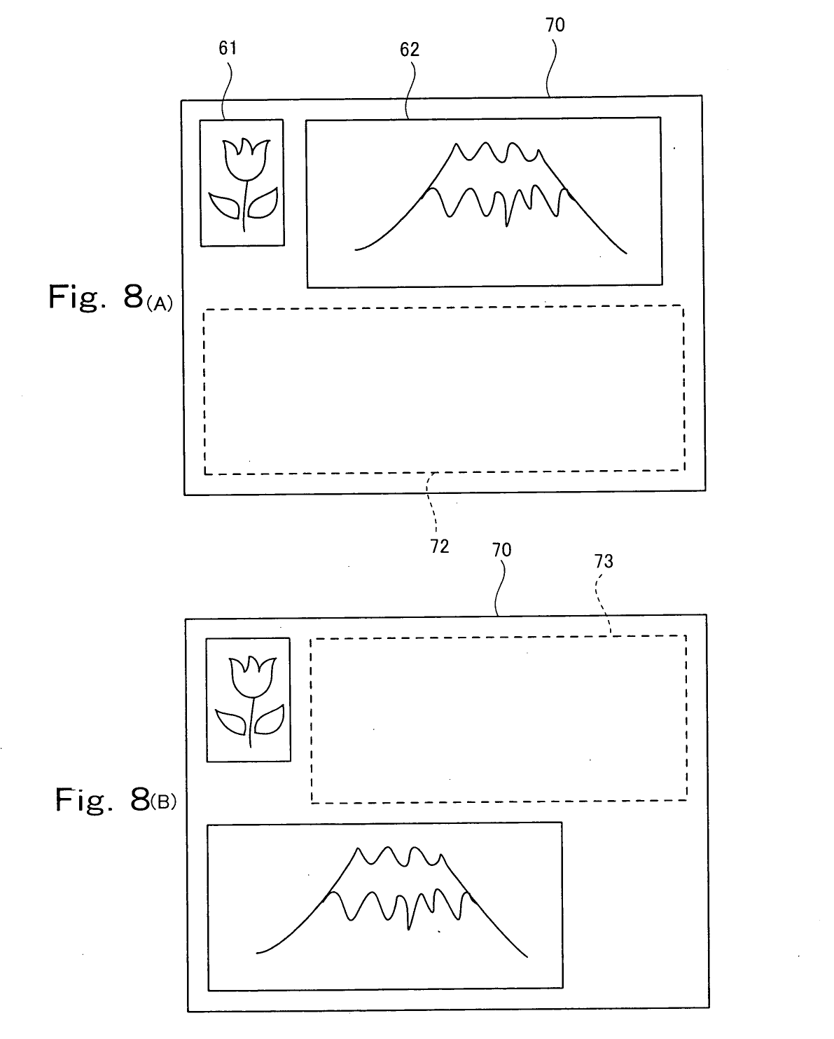

FIGS. 8(A) and 8(B) show conceptual images of the sheet in which a second image is placed according to the algorithm. If the second image 62 is placed at the upper right of the sheet 70 in the state shown in FIG. 7, a rectangle 72 is the largest rectangle in the remaining region after placement of the images 61 and 62. Alternatively, as shown in FIG. 8(B), if the image 62 is placed at the lower left of the sheet 70, a rectangle 73 is the largest rectangle in the remaining region after placement of the images 61 and 62. Since the rectangle 72 is larger than the rectangle 73, the image 62 is place at the upper right of the sheet 70 as shown in FIG. 8(A).

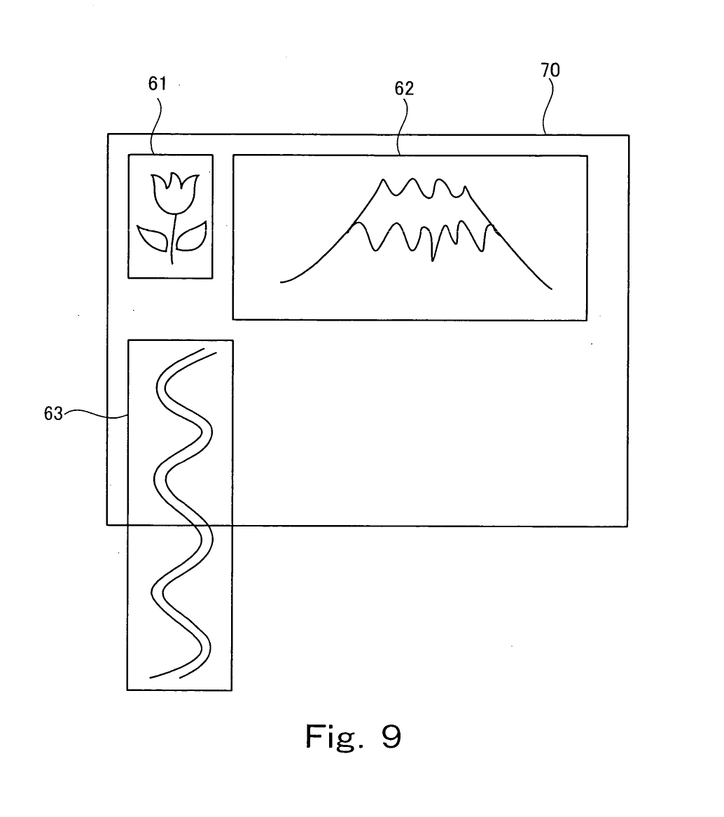

FIG. 9 shows a conceptual image of the sheet in which a third image is placed according to the algorithm. When the image 63, which is the third to be transmitted, is placed in the remaining region in the sheet 70 in the state shown in FIG. 8 (A), the image 63 extends off the sheet 70 as shown in FIG. 9. The first area calculation section 51 calculates the first total sum, which is a total sum of the areas of the images 61 and 62 contained in the sheet 70 in a first arrangement. In addition, the first area calculation section 51 informs the second area calculation section 52 that the image 63 is the extending-off image. The calculation of the first total sum performed by the first area calculation section is an example of a first area calculation step in an image arrangement method according to the present invention.

Once the first total sum is calculated by the first area calculation section 51, the second area calculation section 52 calculates the total sum of the areas of the images that can be contained in the sheet when the four images 61, 62, 63 and 64 shown in FIG. 6 are arranged in the sheet according to the algorithm in the second order (the extending-off image or another image which is the last to be placed by the first area calculation section 51 is first placed, and thereafter, the remaining images are placed in the order of transmission thereof). In this example, since there is an extending-off image when the images are arranged in the first order, the extending-off image is placed first.

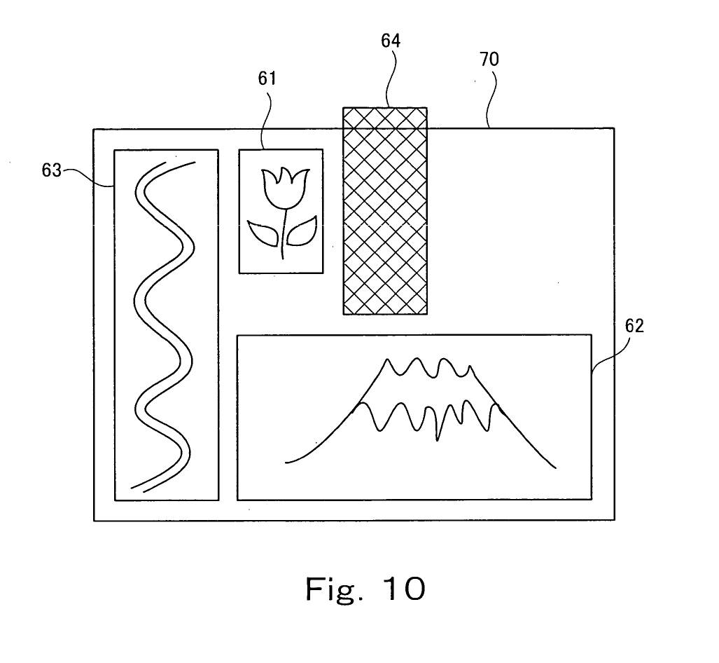

FIG. 10 shows a conceptual image of the sheet in which the images are placed in the second order according to the algorithm. The image 63, which is the extending-off image, is first placed at the upper left of the sheet 70. Then, the image 61, which is the first to be transmitted, is placed at the right of the image 63 toward the upper edge of the sheet 70, and the second image 62 is placed at the right of the image 63 toward the lower edge of the sheet 70. At this time, when the fourth image 64 is placed in the remaining region of the sheet 70, it extends off the sheet. Therefore, the second area calculation section 52 calculates the total sum of the areas of the images contained in the sheet 70 in a second arrangement (images 61, 62, 63) as the second total sum. The calculation of the second total sum performed by the second area calculation section 52 is an example of a second area calculation step in the image arrangement method according to the present invention.

Once the first and second total sums are calculated, the image arrangement section 53 compares the first and second total sums with each other and arranges the plurality of images in the sheet using the arrangement which provides the larger total sum. In this example, since the first total sum is the total sum of the areas of the images 61 and 62 shown in FIG. 9, and the second total sum is the total sum of the areas of the images 61, 62 and 63 shown in FIG. 10, the second total sum is larger than the first total sum. Therefore, the image arrangement section 53 places the images 61, 62 and 63 in the sheet 70 in the arrangement that is adopted when the second total sum is calculated (arrangement of the images 61, 62 and 63 shown in FIG. 10). Furthermore, the image arrangement section 53 transmits the sheet image representing the whole sheet to the color printer 30 shown in FIG. 1 via the output interface 217 shown in FIG. 3. The arrangement of the images into the sheet by the image arrangement section 53 is an example of an image arrangement step in the image arrangement method according to the present invention.

The sheet image transmitted to the color printer 30 is printed out onto a sheet of paper by the color printer 30. In the sheet of paper 70 at this time, the images 61, 62 and 63 shown in FIG. 10 are arranged without extending off the sheet 70.

In this way, since each image is placed so that the remaining area of the sheet can accommodate a possible largest rectangle, a plurality of image can be arranged in the sheet in such a manner that the minimum blank area is left. In addition, since a plurality of image arrangements are provided by arranging a plurality of images according to a predetermined algorithm in plural arrangement orders, and an arrangement in which a maximum number of images can be arranged is selected, one sheet of paper can be efficiently used.

So far, the first embodiment of the present invention has been described. In the following, an image arrangement device according to a second embodiment of the present invention will be described. In the first embodiment, in order to provide a plurality of image arrangements, a method of arranging a plurality of images according to a predetermined algorithm in plural arrangement orders is adopted. However, in the second embodiment, a method of arranging a plurality of images in a predetermined arrangement order according to plural algorithms is adopted. While FIG. 5 is a diagram showing the image arrangement device 50 according to the first embodiment, FIG. 5 is used also in this second embodiment. And, only differences from the first embodiment will be described.

A first area calculation section according to this embodiment calculates a first total sum, which is a total sum of the areas of images that can be contained in a sheet of paper when a plurality of images are arranged in the sheet in a predetermined order according to a first algorithm (described later). In this embodiment, the first algorithm adopted is the algorithm that is adopted in the first embodiment (a high priority is given to the upper left of the sheet, and each image is placed so that the remaining blank area of the sheet can accommodate a possible largest rectangle). The predetermined order adopted is the first order adopted in the first embodiment (the order of transmission of the images to the image arrangement device). Therefore, the first area calculation section in this embodiment performs the same processing as that performed by the first area calculation section in the image arrangement device 50 in the first embodiment. The predetermined order is an example of a predetermined order according to the present invention, and the first algorithm is an example of a first algorithm according to the present invention.

Unlike the second area calculation section 52 in the first embodiment, a second area calculation section calculates a second total sum, which is a total sum of the areas of images that can be contained in a sheet of paper when the plurality of images are arranged in the sheet in the predetermined order according to a second algorithm (described later). In this embodiment, the second algorithm adopted is a combination of the conditions of the first algorithm (a high priority is given to the upper left of the sheet, and each image is placed so that the remaining blank area of the sheet can accommodate a possible largest rectangle) and a condition that an image can be rotated for placement. The second algorithm is an example of a second algorithm according to the present invention.

Similar to the image arrangement section 53 in the first embodiment, an image arrangement section compares the first total sum calculated by the first area calculation section with the second total sum calculated by the second area calculation section and places the images in an arrangement for which the larger total sum results.

While FIGS. 6 to 10 are diagrams showing images transmitted to the image arrangement device 50 in the first embodiment and conceptual images of sheets in which the images are arranged, FIGS. 6 to 10 are used also in the second embodiment. In the following, a sequence of processings of arranging a plurality of images in a sheet of paper will be described with reference to the drawings.

As in the first embodiment, four images 61, 62, 63 and 64 shown in FIG. 6 are sequentially transmitted to the image arrangement device according to this embodiment.

The first area calculation section shown in FIG. 5 calculates a total sum of the areas of images that can be contained in the sheet of paper when the images are arranged in the sheet in the predetermined order (order of transmission of the images) according to the first algorithm (a high priority is given to the upper left of the sheet, and each image is placed so that the remaining blank area of the sheet can accommodate a possible largest rectangle). Since the first algorithm and the predetermined order are the same as the algorithm and the first order used in the first area calculation section 51 in the first embodiment, respectively, the conceptual image of the sheet having the images 61, 62, 63 and 64 arranged therein generated under these conditions is the same as the conceptual image of the sheet 70 shown in FIG. 9. Therefore, the first total sum in this example is the total sum of the areas of the images 61 and 62.

Once the first total sum is calculated, the second area calculation section calculates the total sum of the areas of the images that can be contained in the sheet when the plurality of images shown in FIG. 6 are arranged in the sheet in the predetermined order according to the second algorithm (a combination of the conditions of the first algorithm and a condition that an image can be rotated for placement).

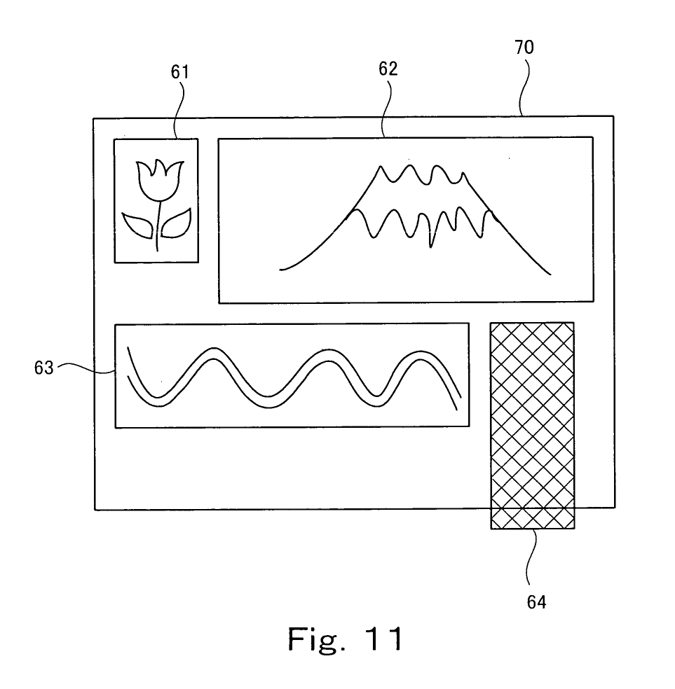

FIG. 11 shows a conceptual image of the sheet in which the images are placed in the predetermined order according to the second algorithm. The images are placed in the order of input. That is, the first image 61 is placed toward the left edge of the sheet 70, and the second image 62 is placed at the right of the image 61 toward the upper edge of the sheet 70. Here, since the second algorithm permits rotation of images, the image 63, which extends off the sheet 70 in FIG. 9, is rotated by 90 degrees and placed in the sheet 70 without extending off the sheet in FIG. 11. The fourth image 64 placed after the image 63 extends off the sheet 70, and therefore, the second area calculation section calculates, as the second total sum, the total sum of the areas of the images other than the image 64 (images 61, 62 and 63).

Once the first and second total sums are calculated, the image arrangement section compares them with each other and places the plurality of images in the sheet in the arrangement which provides the larger total sum. In this example, since the first total sum is the total sum of the areas of the images 61 and 62 shown in FIG. 9, and the second total sum is the total sum of the areas of the images 61, 62 and 63 shown in FIG. 11, the second total sum is larger than the first total sum. Therefore, the image arrangement section places the images in the sheet 70 in the arrangement that is adopted when the second total sum is calculated (arrangement of the images 61, 62 and 63 shown in FIG. 11).

In this way, since a plurality of image arrangements are provided by arranging a plurality of images in a predetermined arrangement order according to plural algorithms, and an arrangement in which a maximum number of images can be arranged is selected, one sheet of paper can be efficiently used.

So far, the second embodiment of the present invention has been described. Now, an image arrangement device according to a third embodiment of the present invention will be described. In the following, to avoid overlaps, elements configured the same as those in the first and second embodiments are assigned the same reference numerals and descriptions thereof are omitted. And, description will be made with reference to differences from the first and second embodiments.

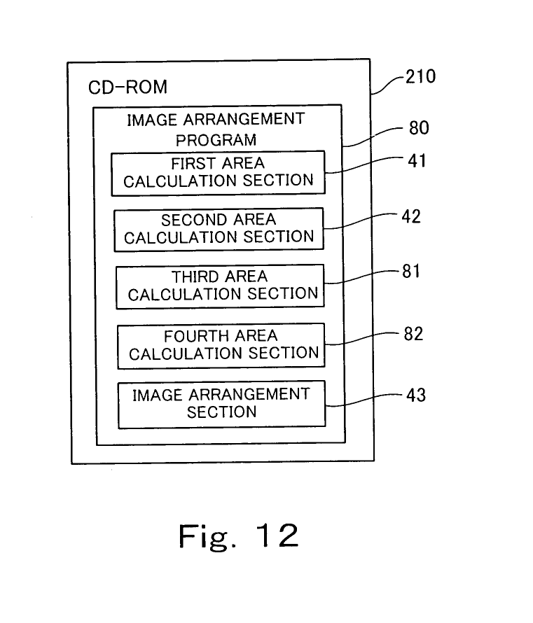

FIG. 12 is a conceptual diagram showing a CD-ROM 210, which is a second embodiment of the image arrangement program storage medium according to the present invention.

An image arrangement program 80 stored in the storage medium according to this embodiment comprises a first area calculation section 41, a second area calculation section 42, an image arrangement section 43, a third area calculation section 81 and a fourth area calculation section 82. The third area calculation section 81 is an example of a third area calculation section in the image arrangement program according to the present invention. Similarly, the fourth area calculation section 82 is an example of a fourth area calculation section in the image arrangement program according to the present invention.

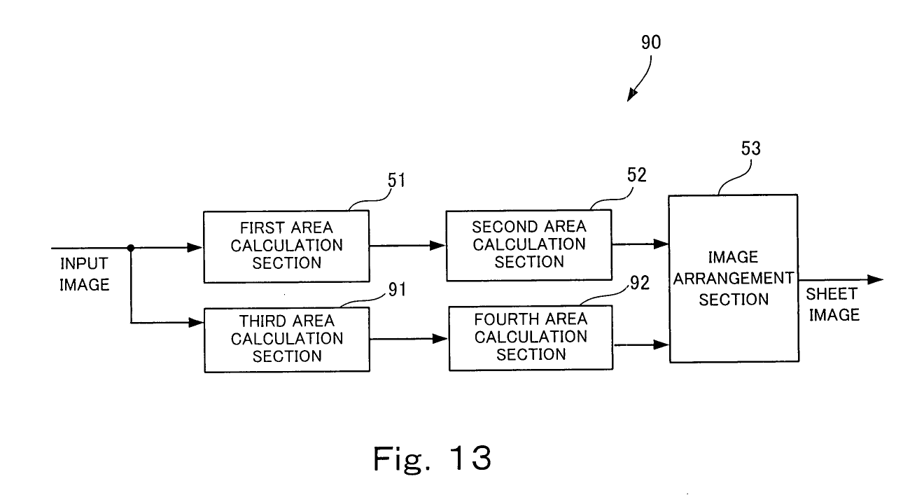

FIG. 13 is a functional block diagram of an image arrangement device 90, which is the personal computer 20 shown in FIG. 1 having the image arrangement program 80 installed therein from the CD-ROM 210, rather than the CD-ROM 110, and functioning as the image arrangement device according to the third embodiment of the present invention.

The image arrangement device 90 shown in FIG. 13 comprises a first area calculation section 51, a second area calculation section 52, an image arrangement section 53, a third area calculation section 91 and a fourth area calculation section 92. Once the image arrangement program 80 shown in FIG. 12 is installed in the personal computer 20, the third area calculation section 81 of the image arrangement program 80 constitutes the third area calculation section 91 in FIG. 13, and similarly, the fourth area calculation section 82 constitutes the fourth area calculation section 92.

A plurality of images having different sizes or shapes read by the color scanner 10 in FIG. 1 are transmitted to the image arrangement device 90 shown in FIG. 13 through the input interface 216 shown in FIG. 3.

The first area calculation section 51 calculates a first total sum, which is a total sum of the areas of images that can be contained in a sheet of paper when the plurality of images are arranged in the sheet in a first order according to a first algorithm. In this embodiment, the first algorithm adopted is the algorithm that is adopted in the first area calculation section 51 in the first embodiment (a high priority is given to the upper left of the sheet, and each image is placed so that the remaining blank area of the sheet can accommodate a possible largest rectangle), and the first order adopted is the first order adopted in the first embodiment (the order of transmission of the images).

The second area calculation section 52 calculates a second total sum, which is a total sum of the areas of images that can be contained in a sheet of paper when the plurality of images transmitted to the image arrangement device 90 are arranged in the sheet in a second order according to the first algorithm. In this embodiment, the second order adopted in the second area calculation section 52 in the first embodiment is adopted, in which an extending-off image or another image which is the last to be placed by the first area calculation section 51 is first placed, and thereafter, the remaining images are placed in the order of transmission thereof.

The third area calculation section 91 calculates a total sum of the areas of the images that can be contained in a sheet of paper when a plurality of images transmitted to the image arrangement device 90 is arranged in the first order according to a second algorithm (the total sum calculated by the third area calculation section will be referred to as a third total sum, hereinafter). In this embodiment, the second algorithm adopted is the same as the algorithm adopted in the second area calculation section in the second embodiment (that is, a combination of the conditions of the first algorithm described above and a condition that an image can be rotated for placement). In addition, as with the first area calculation section 51, the third area calculation section 91 provides information about an extending-off image resulting when the plurality of images are arranged in the sheet in the first order according to the second algorithm and informs the fourth area calculation section 92 of the extending-off image.

The fourth area calculation section 92 calculates a total sum of the areas of the images that can be contained in a sheet of paper when the plurality of images transmitted to the image arrangement device 90 are arranged in the second order according to the second algorithm (the total sum calculated by the fourth area calculation section will be referred to as a fourth total sum, hereinafter).

The image arrangement section 53 makes comparison among the first total sum calculated by the first area calculation section 51, the second total sum calculated by the second area calculation section 52, the third total sum calculated by the third area calculation section 91 and the fourth total sum calculated by the fourth area calculation section and places the images in a sheet of paper in an arrangement for which the largest total sum results.

While FIGS. 6 to 10 are diagrams showing images transmitted to the image arrangement device in the first and second embodiments and conceptual images of sheets in which the images are arranged, FIGS. 6 to 10 are used also in the third embodiment. In the following, a sequence of processings of arranging a plurality of images in a sheet of paper will be described with reference to the drawings.

As in the first and second embodiments, four images 61, 62, 63 and 64 shown in FIG. 6 are sequentially transmitted to the image arrangement device according to this embodiment.

Since the first area calculation section 51 shown in FIG. 13 adopts the first algorithm and the first order, it calculates the first total sum provided when images shown in FIG. 6 are arranged as shown in FIG. 9, as with the first area calculation section 51 in the first embodiment shown in FIG. 5. The first area calculation section 51 calculates the total sum of the areas of the images contained in the sheet 70 in FIG. 9 (images 61 and 62), and informs the second area calculation section 52 that the image 63 is an extending-off image.

The second area calculation section 52, which adopts the first algorithm and the second order, conducts the same processing as that for the second area calculation section 52 in the first embodiment shown in FIG. 5. In this example also, the image 63, which is an extending-off image, is placed first in the sheet, and the second total sum provided when images shown in FIG. 6 are arranged as shown in FIG. 10 is calculated. The second area calculation section 52 calculates the total sum of the areas of the images contained in the sheet 70 in FIG. 10 (images 61, 62 and 63).

The third area calculation section 91, which adopts the second algorithm and the first order, calculates the third sum provided when images shown in FIG. 6 are arranged as shown in FIG. 11, as with the second area calculation in the second embodiment. The third area calculation section 91 calculates the total sum of the areas of the images contained in the sheet 70 in FIG. 11 (images 61, 62 and 63), and informs the fourth area calculation section 92 that the image 64 is an extending-off image. The calculation of the third total sum performed by the third area calculation section 91 is an example of a third area calculation step in the image arrangement method according to the present invention.

The fourth area calculation section 92 calculates the fourth total sum, which is provided when the four images 61, 62, 63 and 64 shown in FIG. 6 are arranged according to the second algorithm in the second order.

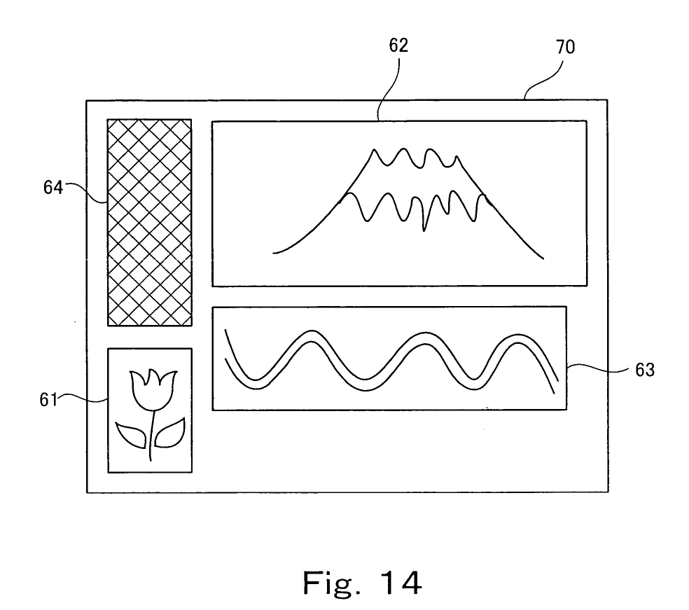

FIG. 14 shows a conceptual image of the sheet in which the images are placed in the second order according to the second algorithm. The image 64, which would otherwise be an extending-off image, is placed first at the upper left of the sheet 70. Then, the image 61, which is the first to be transmitted to the second area calculation section, is placed at the lower left of the sheet 70, the second image 62 is placed at the upper right of the sheet 70, and then, the third image 63 is placed below the image 62. The fourth area calculation section 92 in FIG. 13 calculates the fourth total sum, which is the total sum of the areas of the images contained in the sheet 70 in FIG. 14 (images 61, 62, 63 and 64). The calculation of the fourth total sum performed by the fourth area calculation section 92 is an example of a fourth area calculation step in the image arrangement method according to the present invention.

Once the first, second, third and fourth total sums are calculated, the image arrangement section 53 in FIG. 13 makes comparison among them and places a plurality of images in the sheet in the arrangement which provides the largest total sum. In this example, the fourth total sum is the largest, and in the arrangement that is adopted when the fourth total sum is calculated, all of the four images 61, 62, 63 and 64 are arranged in the sheet 70 without extending off the sheet. Therefore, the image arrangement section 53 places the images in the sheet 70 in the arrangement that is adopted when the fourth total sum is calculated (arrangement of the images 61, 62, 63 and 64 shown in FIG. 14).

In this way, since various image arrangements are provided by combination of plural image arrangement algorithms and plural arrangement orders, and an arrangement in which a maximum number of images can be arranged in the sheet is selected, one sheet of paper can be further efficiently used.

In the above description, the image arrangement device has been described which adopts, as the first order, the order of input of the images, and, as the second order, the order that an extending-off image or another image which is the last to be placed by a calculation section that precedes is first placed, and then, the remaining images are placed in the order of transmission thereof. However, in the image arrangement device according to the present invention, the first and second orders are not limited to the above-described orders.

Furthermore, in the above description, the image arrangement device has been described which arranges images using the algorithm that a high priority is given to the upper left of the sheet, and each image is placed so that the remaining blank area of the sheet can accommodate a possible largest rectangle. However, the algorithm adopted by the image arrangement device according to the present invention is not limited thereto. For example, the image arrangement device according to the present invention may adopt an algorithm that images are sequentially placed close to the left edge of the sheet, and once there is no blank area close to the left edge of the sheet, the remaining images are sequentially placed close to the right edge of the sheet.

What is claimed is:

1. An image arrangement method, comprising:
a first area calculation step of calculating a total sum of the areas of images, of a plurality of images, that are contained in a sheet of paper in a first arrangement;
a second area calculation step of calculating a total sum of the areas of images, of a plurality of images, that are contained in the sheet of paper in a second arrangement different from the first arrangement; and
an image arrangement step of arranging images in the sheet of paper in an arrangement that is adopted when the larger one of the total sums calculated in the first and second area calculation steps is calculated.

2. The image arrangement method according to claim 1, wherein the first area calculation step is to calculate a total sum of the areas of images, of the plurality of images, that are contained in the sheet of paper in the first arrangement, the first arrangement resulting from arranging the plurality of images in the sheet of paper sequentially in a first order according to a predetermined algorithm, and
the second area calculation step is to calculate a total sum of the areas of images, of the plurality of images, that are contained in the sheet of paper in the second arrangement, the second arrangement resulting from arranging the plurality of images in the sheet of paper sequentially in a second order different from the first order according to the predetermined algorithm.

3. The image arrangement method according to claim 2, wherein, if an image extends off the sheet of paper when the plurality of images are arranged in the sheet of paper in the first order, the second order adopted in the second area calculation step to calculate the total sum is that the extending-off image is placed first in the sheet.

4. The image arrangement method according to claim 2, wherein the algorithm is that each of the plurality of images is sequentially arranged in the sheet of paper so that the remaining blank area can accommodate a possible largest rectangle.

5. The image arrangement method according to claim 1, wherein the first area calculation step is to calculate a total sum of the areas of images, of the plurality of images, that are contained in the sheet of paper in the first arrangement, the first arrangement resulting from arranging the plurality of images in the sheet of paper sequentially in a predetermined order according to a first algorithm, and
the second area calculation step is to calculate a total sum of the areas of images, of the plurality of images, that are contained in the sheet of paper in the second arrangement, the second arrangement resulting from arranging the plurality of images sequentially in the sheet of paper in the predetermined order according to a second algorithm different from the first algorithm.

6. The image arrangement method according to claim 1, wherein the first area calculation step is to calculate a total sum of the areas of images, of the plurality of images, that are contained in the sheet of paper in the first arrangement, the first arrangement resulting from arranging the plurality of images in the sheet of paper sequentially in a first order according to a first algorithm,
the second area calculation step is to calculate a total sum of the areas of images, of the plurality of images, that are contained in the sheet of paper in the second arrangement, the second arrangement resulting from arranging the plurality of images in the sheet of paper sequentially in a second order different from the first order according to the first algorithm,
the image arrangement method further comprises:
a third area calculation step of calculating a total sum of the areas of images, of the plurality of images, that are contained in the sheet of paper in a third arrangement, the third arrangement resulting from arranging the plurality of images in the sheet of paper sequentially in the first order according to a second algorithm different from the first algorithm; and
a fourth area calculation step of calculating a total sum of the areas of images, of the plurality of images, that are contained in the sheet of paper in a fourth arrangement, the fourth arrangement resulting from arranging the plurality of images in the sheet of paper sequentially in the second order according to the second algorithm, and
the area arrangement step is to arrange the images in the sheet of paper in an arrangement that is adopted when the largest one of the total sums calculated in the first, second, third and fourth area calculation steps is calculated.

7. An image arrangement device, comprising:
a first area calculation section that calculates a total sum of the areas of images, of a plurality of images, that are contained in a sheet of paper in a first arrangement;
a second area calculation section that calculates a total sum of the areas of images, of a plurality of images, that are contained in the sheet of paper in a second arrangement different from the first arrangement; and
an image arrangement section that arranges images in the sheet of paper in an arrangement that is adopted when the larger one of the total sums calculated by the first and second area calculation sections is calculated.

8. An image arrangement program storage medium that stores an image arrangement program, the image arrangement program comprising:
a first area calculation section that calculates a total sum of the areas of images, of a plurality of images, that are contained in a sheet of paper in a first arrangement;
a second area calculation section that calculates a total sum of the areas of images, of a plurality of images, that are contained in the sheet of paper in a second arrangement different from the first arrangement; and
an image arrangement section that arranges images in the sheet of paper in an arrangement that is adopted when the larger one of the total sums calculated by the first and second area calculation sections is calculated.
